(19) United States
(12) Patent Application Publication
(10) Pub. No.: US 2006/0038122 A1
(43) Pub. Date: Feb. 23, 2006

(54) Ion source with adjustable ion source pressure combining ESI-, FI-, FD-, LIFDI- and MALDI-elements as well as hybrid intermediates between ionization techniques for mass spectrometry and/or electron paramagnetic resonance spectrometry

(76) Inventor: H. Bernhard Linden, Leeste/Weyhe (DE)

Correspondence Address: Walter A. Rodgers, 880 North Island Drive, Atlanta, GA, 30327, US

(21) Appl. No.: 10/921,275

(22) Filed: Aug. 19, 2004

(51) Int. Cl. B01D 59/44

(52) U.S. Cl. 250/290; 250/292

(57) ABSTRACT

The invention refers to techniques effecting a soft ionization of analyte substances by ESI, FI, FD, LIFDI, or MALDI or by hybrids thereof in one and the same ion volume without changing ion sources by suited adjustment of pressure, laser radiation, and electrical field strength and detection of the formed ions or radical ions by means of mass spectrometry and/or electron paramagnetic resonance spectrometry.

### BACKGROUND OF THE INVENTION

The present invention relates to devices for analysis of solid, liquid, or gaseous analyte substances released from surfaces of special electrodes.

Soft ionization of sensitive, thermally labile compounds is known to occur with techniques like Electro-Spray-Ionization (ESI), Field Ionization (FI), Field Desorption (FD), Liquid Injection Field Desorption Ionization (LIFDI) or Matrix Assisted Laser Desorption Ionization (MALDI). These techniques differ in substantial features and have their specific merits and demerits each, as exemplary outlined below.

The special electrode of ESI has typically the shape of a sharp tip of a needle or capillary, out of which the analyte solution is sprayed under the influence of an electrical field generated by a potential drop of ca. 3-5 kV between the spray tip and a counter electrode. Micro-droplets of the solution, which exit from the tip as a fine cloud, carry one or several elemental charges each. On their way to the orifice of the counter electrode, the droplets are de-solvated by means of drying gas and end up as singly or multiply charged ions which are aspirated into the vacuum of a mass spectrometer through a skimmer or a transfer capillary. The ionization principle is the transformation of dissolved ions from the liquid phase of micro-droplets into the gas phase. The ionization is performed under ambient pressure.

The special electrodes of FI, FD and LIFDI have typically the shape of thin wires covered with numerous micro-dendrites onto which gaseous molecules impinge continuously in case of FI, whereas a small batch of dissolved molecules is deposited discontinuously to the micro-dendrites in case of FD, and either can happen in case of LIFDI i.e. continuous as well as discontinuous supply of dissolved or gaseous analyte molecules. The evaporation of the solvent is usually finished in case of FD, before a voltage of ca. 10-12 kV between the respective electrode wire and the counter electrode is applied.

The field strength at the tips of the dendrites is in the order of 10¹⁰ V/m and provides for quantum-mechanical tunneling of electrons from adsorbed analyte molecules into the dendrites. The ions, formed this way, are positively charged and desorb from the anodic dendrites by Coulomb repulsion. The ionization principle is the removal of an electron from the analyte molecule by quantum-mechanical tunneling at a very high field strength and desorption of the ions. The ionization is performed at a vacuum in the order of ca. 10⁻⁵ mbar or better.

The special electrode of MALDI has typically the shape of a flat surface or a surface with many small cavities for deposition of solutions of an analyte-matrix-mixture. Usually the deposition takes place under ambient pressure and is discontinuous. The evaporation of the solvent from the surface is conventionally finished before the so called MALDI target is introduced into the ion source vacuum. The adsorbed mixture of analyte and matrix is exposed to laser shots of a wave length which matches the light absorption of the matrix molecules. The ionization principle is the rapid absorption of the laser energy by the matrix, which is flash evaporated together with the embedded analyte molecules. Sufficient analyte ions are evaporated or generated in the plume, even if most matrix and analyte molecules are evaporated as neutrals. The ionization is performed at a vacuum in the order of ca. 10⁻⁵ mbar or better.

ESI, FI and continuous flow LIFDI are continuous techniques with a continuous supply of analyte and a continuous ionization of it. These techniques can successfully be coupled to chromatographic separation methods: ESI with liquid chromatography (LC), FI with gas chromatography (GC), and LIFDI with both of them.

FD and MALDI are more or less discontinuous techniques with a usually discontinuous sample supply, whereby the MALDY ionization is intrinsically discontinuous, too, whereas FD is a continuous ionization as long as the sample amount lasts which is deposited onto the electrode wire.

In case of analyte mixtures, MALDI can evaporate all components of the mixtures in each distinct laser shot while FD ionizes temperature dependent by ramping the heating current of the electrode wire effecting a fractionated desorption of the components of a mixture one after the other depending on the components' thermal properties and the respective temperature of the wire.

All said ionization techniques are more or less different in terms of classes of compounds they are able to ionize successfully: FI and LIFDI are the only techniques able to ionize gaseous samples. ESI and MALDI are efficient at ionizing sample solutions or sample-matrix-mixtures which contain pre-formed ions or at least molecules with readily ionizable sites like hetero-atoms, polar, or other sites to which e.g. protons, alkali or halogen ions can be attached. Seriously non-polar substances like paraffins or other hydrocarbons can not be ionized with a reasonable yield by ESI and MALDI, whereas FI, FD, and LIFDI are very efficient at ionizing such non-polar samples in all states of aggregation.

An ion source which provides for alternative use of each of the said ionization techniques without time consuming change over of instrumental hardware would be a big advantage for mass spectrometry (MS) and/or electron paramagnetic resonance (EPR) spectrometry due to complementary experimental results. Such a combination of five distinct ion sources in one and the same volume does not exist yet for MS and/or EPR up to date.

### BRIEF SUMMERY OF THE INVENTION

The invention refers to techniques effecting a soft ionization of analyte substances by ESI, FI, FD, LIFDI, or MALDI or by hybrids thereof in one and the same ion volume without changing ion sources by suited adjustment of pressure, laser radiation, and electrical field strength and detection of the formed ions or radical ions by means of MS and/or EPR spectrometry.

### BRIEF DESCRIPTION OF THE DRAWING 1

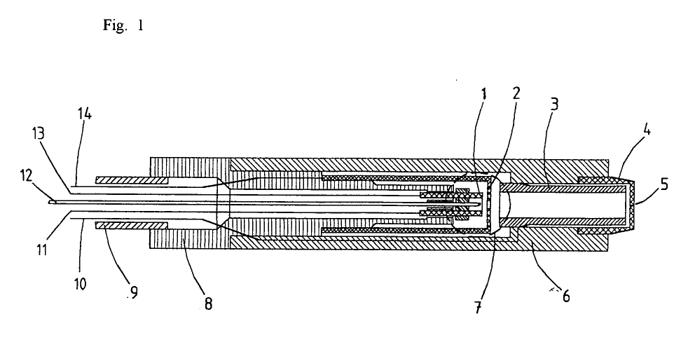

The invention is depicted in FIG. 1. FIG. 1 shows the cross section of a heatable FI, FD, or LIFDI electrode 1 with electrical supplies 11 and 13 and a counter electrode 2 with electrical supply 14. A sample introduction capillary 12 is coordinated to the electrode 1. The ion cooling/desolvation volume 3 has an electrical supply 11. The extraction electrode 4 with adjustable orifice 5 tightens the isolation body 6, which has a window 7 outside of the cross section plane as shown dashed. The isolating body 8 is attached to a probe shaft 9 which extends up to a probe handle which is not shown. The handle comprises feedthroughs for the electrical supplies 10, 11, 13, and 14 and for the capillary 12 as well as a valve for supply of a cooling/desolvation gas and for adjustment of the pressure of said gas.

### DETAILED DESCRIPTION OF THE INVENTION

It is an object of the present invention, to combine a variety of ion formation and ion detection means creating an ion source which comprises essential features of the five ionization techniques ESI, FI, FD, LIFDI, and MALDI enabling ionization by spraying, by means of a very high electrical field, or by laser radiation in one and the same source volume one after the other or in part simultaneously for analysis of the formed ions by the distinct detection means mass spectrometry and/or electron paramagnetic resonance spectrometry of radical ions in order to collect complementary information.

The object is solved in that way that the special electrode of FI, FD, and LIFDI which is normally used for enhancement of the electrical field strength, is also used as light absorbing MALDI target surface and as an alignment of micro-droplets-emitting-micro-protrusions as well as a source of radicals for EPR with adjustable vacuum, adjustable electrical field strength, and adjustable laser radiation, enabling to provide for hybrid transitions between various ionization techniques for instance by pulsed heating of the sample covered FI/FD/LIFDI electrode by laser radiation with the opportunity to analyze by means of FI neutral particles, which are evaporated by MALDI and lost in a pure MALDI analysis, or to analyze by means of FD what remains on the MALDI target after laser radiation.

The embodiment of the invention, described in the claims, effects that analyte substances are amenable to analysis by various ionization techniques and various detection methods without substantial change of hardware i.e. without experimental effort by suitable adjustment of pressure, field strength, and laser radiation and by suitable supply of the formed ions or radical ions to a mass spectrometer and/or a EPR spectrometer.

In addition to the quick and experimentally easy switching from one ionization technique to another one, there is the big advantage that for the first time hybrid transitions between distinct ionization techniques become possible providing for extra information for example on otherwise undiscovered MALDI neutrals, which is impossible to acquire with distinct ionization techniques.

Another advantage of the invention is that the adjustment of a suitable pressure provides for collisional cooling of FI, FD, or LIFDI generated ions which are normally difficult to focus due to their very high and divergent initial acceleration. Collisionally cooled, these ions can be extracted from the cooling volume as a rather parallel ion beam which can be focused with high yield.

1. Apparatus for analysis of analyte substances ionized by ESI, FI, FD, LIFDI, and/or MALDI characterized in that
formed radical ions and/or even-electron ions are provided from a common electrode.

2. Apparatus for analysis of analyte substances ionized by ESI, FI, FD, LIFDI, and/or MALDI, according to claim 1 characterized in that
the formed ions are analyzed by MS.

3. Apparatus for analysis of analyte substances ionized by ESI, FI, FD, LIFDI, and/or MALDI, according to claim 1 characterized in that
the formed radical ions are analyzed by EPR spectrometry.

4. Apparatus for analysis of analyte substances ionized by ESI, FI, FD, LIFDI, and/or MALDI, according to claim 1 characterized in that
the formed ions are analyzed by MS and EPR spectrometry.

5. Apparatus for analysis of analyte substances ionized by ESI, FI, FD, LIFDI, and/or MALDI, according to claim 1 characterized in that
the common electrode is a special FI/FD/LIFDI electrode.

6. Apparatus for analysis of analyte substances ionized by ESI, FI, FD, LIFDI, and/or MALDI, according to claim 1 characterized in that
the common electrode is a special FI/FD/LIFDI electrode providing an alignment of protruding tips for emission of ESI micro-droplets.

7. Apparatus for analysis of analyte substances ionized by ESI, FI, FD, LIFDI, and/or MALDI, according to claim 1 characterized in that
the common electrode is a special FI/FD/LIFDI electrode providing micro-cavities for MALDI sample/matrix deposition and laser light absorption.

8. Apparatus for analysis of analyte substances ionized by ESI, FI, FD, LIFDI, and/or MALDI, according to claim 1 characterized in that
a suitable ion source pressure is provided inside of the isolation body.

9. Apparatus for analysis of analyte substances ionized by ESI, FI, FD, LIFDI, and/or MALDI, according to claim 1 characterized in that
a suitable ion source pressure is provided inside of the isolation body by means of an adjustable gas supply.

10. Apparatus for analysis of analyte substances ionized by ESI, FI, FD, LIFDI, and/or MALDI, according to claim 1 characterized in that
a suitable ion source pressure is provided inside of the isolation body by means of an adjustable orifice.

11. Apparatus for analysis of analyte substances ionized by ESI, FI, FD, LIFDI, and/or MALDI, according to claim 1 characterized in that
a suitable ion source pressure is provided inside of the isolation body by means of an adjustable orifice as well as by means of an adjustable gas supply.

12. Apparatus for analysis of analyte substances ionized by ESI, FI, FD, LIFDI, and/or MALDI, according to claim 1 characterized in that
a suitable deceleration of quick, divergent ions is provided by means of a collision gas inside of the cooling volume at an adjustable gas pressure.

13. Apparatus for analysis of analyte substances ionized by ESI, FI, FD, LIFDI, and/or MALDI, according to claim 1 characterized in that
a suitable gas supply inside of the cooling volume is provided for desolvation of micro-droplets.

14. Apparatus for analysis of analyte substances ionized by ESI, FI, FD, LIFDI, and/or MALDI, according to claim 1 characterized in that
a suitable electrical field strength between the electrode and the counter electrode is provided by means of a suited power supply.

15. Apparatus for analysis of analyte substances ionized by ESI, FI, FD, LIFDI, and/or MALDI, according to claim 1 characterized in that
a suitable laser radiation is provided through a window by means of an adjustable laser source.

16. Apparatus for analysis of analyte substances ionized by ESI, FI, FD, LIFDI, and/or MALDI, according to claim 1 characterized in that
a suitable laser radiation is provided through a window by means of adjustable laser shots with adjustable repetition rate.

17. Apparatus for analysis of analyte substances ionized by ESI, FI, FD, LIFDI, and/or MALDI, according to claim 1 characterized in that
the apparatus is mounted on a means for introduction in the vacuum of a MS.

18. Apparatus for analysis of analyte substances ionized by ESI, FI, FD, LIFDI, and/or MALDI, according to claim 1 characterized in that
the apparatus is mounted on a means for introduction in the analyzer region of an EPR spectrometer.

19. Apparatus for analysis of analyte substances ionized by ESI, FI, FD, LIFDI, and/or MALDI, according to claim 1 characterized in that
a sample supply is provided by means of a suited capillary.

20. Apparatus for analysis of analyte substances ionized by ESI, FI, FD, LIFDI, and/or MALDI, according to claim 1 characterized in that
electrical supplies are provided for voltages and currents.

21. Apparatus for analysis of analyte substances ionized by ESI, FI, FD, LIFDI, and/or MALDI, according to claim 1 characterized in that
an electrode is provided for alternative use as a vacuum gauge resistor.
